(19) United States
(12) Patent Application Publication
(10) Pub. No.: US 2026/0148338 A1
(43) Pub. Date: May 28, 2026

(54) THREE-DIMENSIONAL SUPER RESOLUTION USING GENERATIVE VIDEO MODELS

(71) Applicant: Adobe Inc., San Jose, CA (US)

(72) Inventors: Yuan Shen, Champaign, IL (US); Zexiang Xu, San Jose, CA (US); Paul Guerrero, London (GB); Niloy Jyoti Mitra, Potters Bar (GB); Duygu Ceylan Aksit, London (GB); Anna Fruehstueck, London (GB)

(73) Assignee: Adobe Inc., San Jose, CA (US)

(21) Appl. No.: 18/958,415

(22) Filed: Nov. 25, 2024

(51) Int. Cl. G06T 3/4053

(52) U.S. Cl. CPC G06T 3/4053; G06T 2200/04

(57) ABSTRACT

In implementing three-dimensional (3D) super-resolution techniques using generative video models, a processing device receives a first 3D representation of an object. The processing device generates an intermediate video of the object from multiple viewpoints of the first 3D representation. A machine-learning model then generates an upsampled video from the intermediate video. The upsampled video is in a higher resolution than the intermediate video. In one example, the machine learning model is a video-based generative upsampler. Based on 3D reconstruction of the object from the upsampled video, the processing device outputs a second 3D representation of the object in a resolution higher than the first 3D representation.

### BACKGROUND

A digital three-dimensional (3D) model is a computer-generated representation of a 3D object. In other words, digital 3D models digitally capture an object's shape, size, and sometimes appearance (e.g., texture). These models have various applications across industries, including animation, video games, architecture, product design, and engineering. For example, digital 3D models bring characters and objects to life in animated videos and video games, providing an immersive and realistic experience. While machine-learning models (e.g., generative models) have made impressive advances to provide realistic images and videos, similar advancements have not been accomplished for 3D modeling. Digital 3D models generated using conventional machine-learning models lack the detail and accuracy required for many applications.

### SUMMARY

Techniques and systems for 3D super-resolution using generative video models are described. In one example, a processing device receives a 3D representation of an object. The 3D representation comes in various formats but is in a low resolution. The processing device generates an intermediate video of the object from multiple viewpoints of the 3D representation. For example, a smooth trajectory is used to capture and stitch together images of the object from different viewpoints. A machine-learning model then generates an upsampled video of the object from the intermediate video. The upsampled video is in a higher resolution than the intermediate video. A second 3D representation of the object is then generated using 3D reconstruction of the object from the upsampled video. The second 3D representation is in a higher resolution than the original 3D representation.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures Entities represented in the figures are indicative of one or more entities and thus reference is made interchangeably to single or plural forms of the entities in the discussion.

FIG. 1 is an illustration of a digital medium environment in an example implementation that is operable to employ techniques and systems for 3D super-resolution of 3D models using generative video models as described herein.

FIG. 2 depicts a system in an example implementation showing an operation of a super-resolution module for 3D super-resolution of 3D models.

FIG. 3 depicts an example of an architecture for a super-resolution module.

FIG. 4 depicts an example of inputs and outputs of a super-resolution module.

FIG. 5 depicts an example of an input scene and output scene of a super-resolution module.

FIG. 6 depicts a procedure in an example implementation of three-dimensional super-resolution using a generative video model.

FIG. 7 illustrates an example system including various components of an example device that can be implemented as any type of computing device as described and/or utilized with reference to FIGS. 1-6 to implement embodiments of the techniques described herein.

### DETAILED DESCRIPTION

### Overview

Machine-learning models, including generative 3D models, have recently been developed to generate digital 3D models. These generative models are optionally conditioned using text prompts or input images. Generally, these conventional models use images and 3D data for supervision to produce diverse results quickly. Unfortunately, the 3D models generated by existing generative models still lack the detail and accuracy of state-of-the-art generative models for images or videos. In contrast, this document describes 3D super-resolution techniques using generative video models to enhance the quality of generated 3D objects.

Multiple challenges contribute to the limitations of 3D models generated by existing generative models. The first is related to the choice of 3D representation. While grid-based models are most popular as they do not need prior knowledge of the (generated) shape, their regular structure (e.g., volume grid or triplanes) limits the fidelity of the generation results. Secondly, acquiring large volumes of high-quality yet diverse 3D data is difficult. While conventional image and video models are trained on several billion training samples, the most extensive 3D training datasets, at best, contain a few million objects.

The described 3D super-resolution techniques using generative video models increase the detail of a coarse 3D model without needing specific training for each object type. 3D representations are rendered from multiple viewpoints along a smooth trajectory and mapped to an intermediate video representation. Existing video models are then used to improve the quality and resolution of the 3D objects in the videos via super-resolution. These conventional video models are trained on large sets of video data, providing strong priors to enhance 3D models represented in video through upsampling.

Using video models, as opposed to image-based models, enhances the consistency over time during upsampling. However, ensuring 3D consistency poses a challenge for super-resolution techniques. While video models are temporally smooth, these models may not necessarily maintain 3D consistency. To address this challenge, a modular approach is developed that seamlessly integrates into existing workflows.

In one implementation, a video of the scene is created from a coarse 3D input model using sampled view trajectories. The generated video is then upsampled using a pre-trained video-based upsampler. This upsampler can be further adjusted to handle artifacts of the input modality. For the 3D consolidation, Gaussian splatting is used as the output representation because it is well-suited for encoding individual objects and capturing local details due to its object-centric nature. Gaussian splats also offer a good balance between simplicity, model fidelity, and rendering efficiency. The described video-based 3D super-resolution framework is adaptable to enhance various coarse 3D modalities (e.g., data types for the input 3D model) by adding geometric and appearance details.

The following discussion describes an example environment that employs the techniques described herein. Example procedures that are performable in the example environment and other environments are also described. Consequently, the performance of the example procedures is not limited to the example environment, and the example environment is not limited to the performance of the example procedures.

### Example Environment

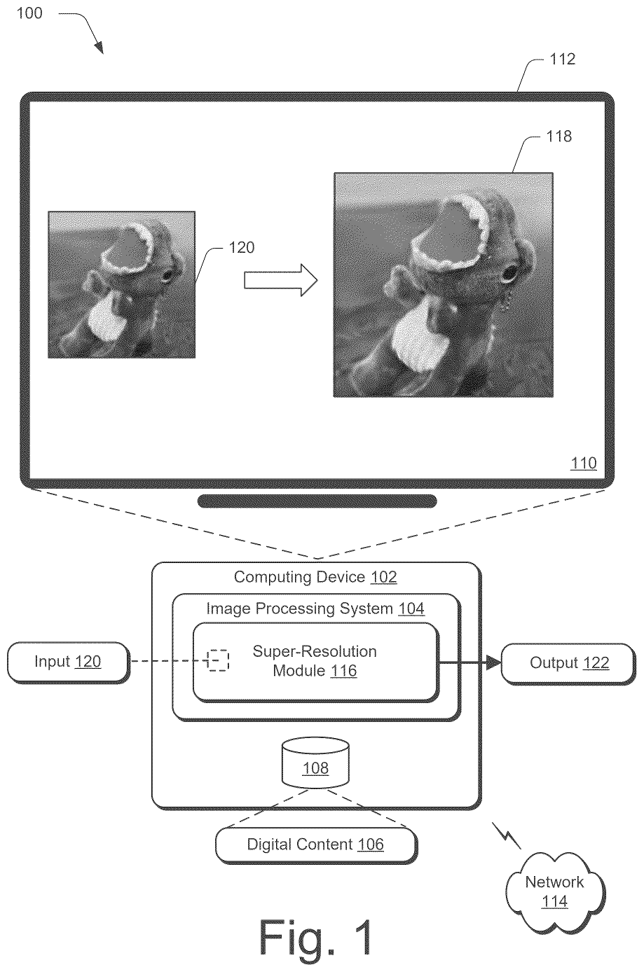

FIG. 1 illustrates a digital medium environment 100 in an example implementation that is operable to employ techniques and systems for 3D super-resolution of 3D models using generative video models as described herein. The illustrated digital medium environment 100 includes a computing device 102, which is configurable in various ways.

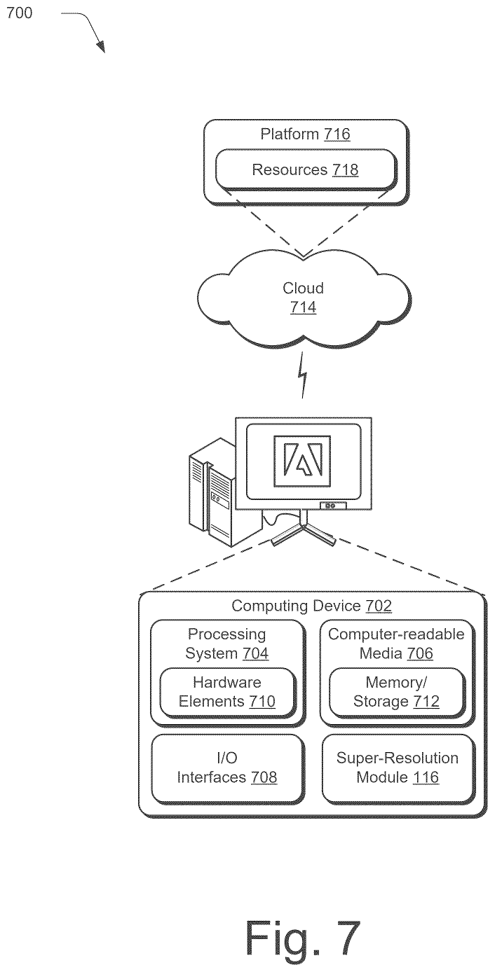

The computing device 102, for instance, is configurable as a desktop computer, a laptop computer, a mobile device (e.g., assuming a handheld configuration such as a tablet or mobile phone), an augmented reality device, and so forth. Thus, computing device 102 ranges from full-resource devices with substantial memory and processor resources (e.g., personal computers and game consoles) to a low-resource device with limited memory and/or processing resources (e.g., mobile devices). Additionally, although a single computing device 102 is shown, the computing device 102 is also representative of a plurality of different devices, such as multiple servers a business utilizes to perform operations “over the cloud” as described in FIG. 7.

The computing device 102 also includes an image processing system 104. The image processing system 104 is implemented at least partially in the hardware of the computing device 102 to process and represent digital content 106, which is illustrated as maintained in storage 108 of the computing device 102. Such processing includes creating the digital content 106, representing the digital content 106, modifying the digital content 106, and rendering the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a super-resolution module 116, which is illustrated as incorporated by the image processing system 104 to process the digital content 106. In some examples, the super-resolution module 116 is separate from the image processing system 104 such as in an example in which the super-resolution module 116 is available via the network 114.

The super-resolution module 116 is configured to generate a high-resolution, 3D model 118 through an upscaling process. For example, the super-resolution module 116 first receives an input 120 as a low-quality or low-resolution 3D model of a digital object or other digital asset. For example, the super-resolution module 116 handles various inputs 120, such as neural radiance fields (NeRFs) (e.g., reconstructions of a 3D scene or object from several 2D images), Gaussian splats (e.g., reconstructions of a 3D scene or object using the combination of 3D Gaussians with properties like position, orientation, size, color, and opacity), 3D reconstructions from scans (e.g., a LiDAR or radar scan), models generated by text-to-3D machine-learning models, or low-poly meshes.

After receiving the input 120, the super-resolution module 116 renders a video of the scene from the course 3D input 120 based on sampled view trajectories. Then, the rendered video is upsampled using a pre-trained video-based upsampler. The upsampler is optionally fine-tuned to handle artifacts of the input modality (e.g., the data type of the input 120). The super-resolution module 116 uses Gaussian splatting to perform 3D consolidation to generate high-resolution 3D outputs 122 with rich geometric and texture details. In other implementations, the super-resolution module 116 uses one or more other formats for the high-resolution 3D outputs 122.

The Gaussian splats generally include millions of 3D Gaussians (e.g., tiny particles), each containing certain properties (e.g., position, orientation, size, color, and/or opacity). During rendering, the image processing system 104 determines how the splats project onto the screen from a specific viewpoint. Because the splats are an object-centric representation, Gaussian splats are well-suited for encoding individual objects and capturing fine details and complex lighting effects, resulting in very realistic and natural-looking scenes. In addition, Gaussian splatting strikes a good balance between simplicity, fidelity of encoded models, and rendering efficiency, making them better suited for real-time rendering and applications like video games and virtual reality.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Three-Dimensional Super Resolution

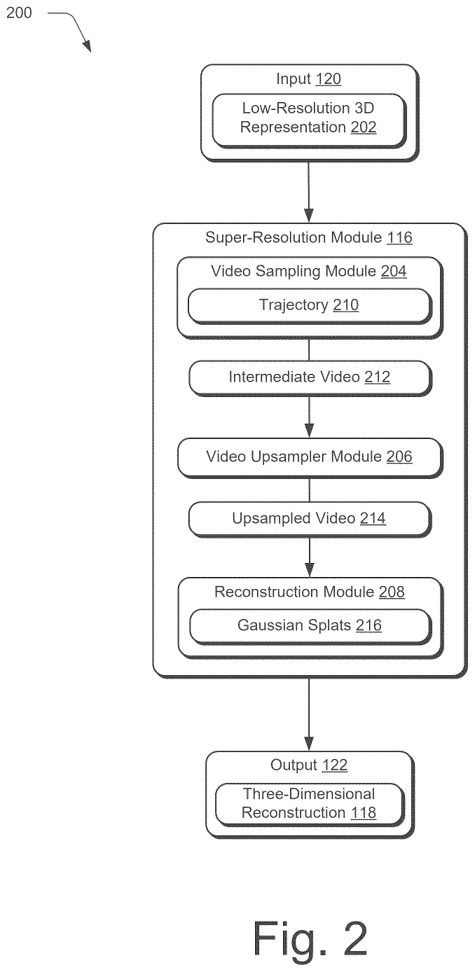

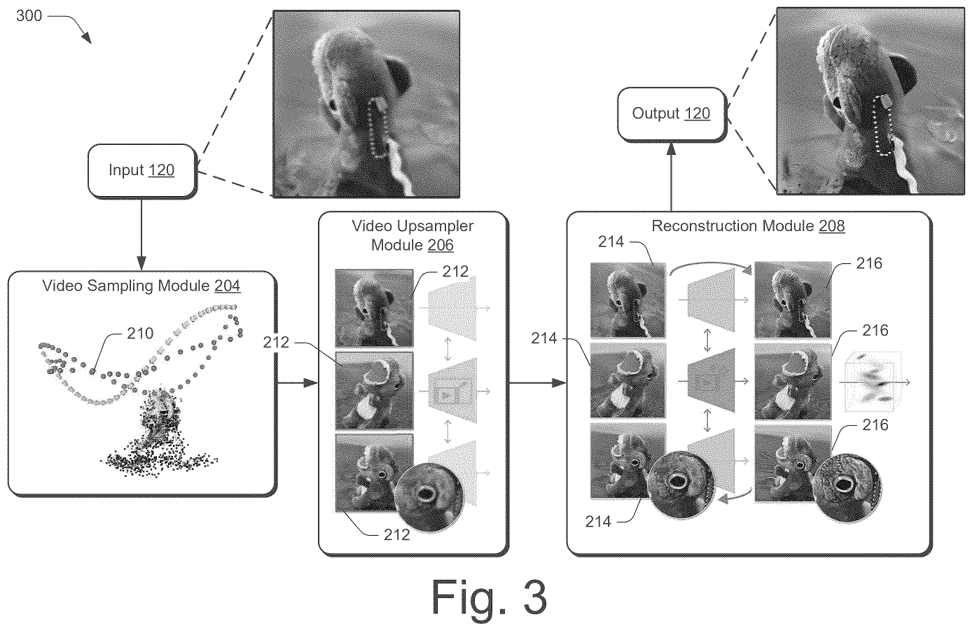

FIG. 2 depicts a system 200 in an example implementation showing operation of a super-resolution module of FIG. 1 in greater detail for super-resolution of 3D models. FIG. 3 depicts an example of an architecture 300 for the super-resolution module of FIG. 1 with example images illustrating the actions performed. The following discussion describes implementable techniques utilizing the previously described systems and devices. Aspects of each procedure are implemented in hardware, firmware, software, or a combination thereof. The procedures are shown as a set of blocks that specify operations performed and/or caused by one or more devices and are not necessarily limited to the orders shown for performing the operations by the respective blocks.

In this example, the super-resolution module 116 receives a low-resolution 3D representation 202 of an object or scene as the input 120, which is also illustrated in FIG. 3 as a low-resolution image of a stuffed dinosaur toy. The low-resolution 3D representation 202 may come in various formats or modalities, including NeRFs, Gaussian splats, 3D reconstructions, or low-poly meshes. NeRF is a deep-learning technique that reconstructs a 3D scene or object from numerous 2D images (e.g., from different angles). The neural network learns the 3D layout of the scene or object, including objects therein and how light interacts with them, to render a scene or object from new viewpoints. 3D reconstructions are generated from LiDAR and similar scanning techniques. Low-poly meshes are a type of 3D model constructed from a small number of polygons (e.g., tiny squares or triangles forming the surface of a 3D object). In other implementations, the low-resolution 3D representation is generated by text-to-3D machine-learning models.

As described, the super-resolution module 116 can handle a diverse set of coarse 3D representations of a static object or scene, denoted φ_{low}. For example, input 120 or φ_{low} can be Gaussian splats, NeRF, a low-poly mesh, a low-quality captured video, or a generated 3D object from text-to-3D machine-learning models. Given a coarse model or low-resolution 3D representation 202, the super-resolution module 116 performs upsampling to improve the fidelity of the 3D representation and capture more local details. Based on the observation that 3D content is representable as a video depicting the 3D scene from multiple viewpoints, the super-resolution module 116 leverages existing video upsampling priors to perform 3D upsampling. The super-resolution module 116 includes a video sampling module 204, a video upsampler module 206, and a reconstruction module 208 to do the upsampling. Each component in system 200 is modularized and can easily be replaced with other video techniques.

The video sampling module 204 uses smooth trajectories 210 to sample the 3D representation, φ_{low}, from multiple viewpoints to generate an intermediate video 212 with a low resolution. FIG. 3 illustrates an example of three smooth trajectories 210 that sample the input 120 to generate three intermediate videos 212. In particular, the sampling module 204 renders each 3D input 120 from N smooth trajectories 210 with viewpoints

$${ξ}_{1 … T}^{1 … N}$$

resulting in a sequence of RGB images

$${I}_{1 … T}^{1 … N} .$$

The subscript indexes the viewpoint or the pose along each trajectory 210, and the superscript denotes the trajectory ID. The video sampling module 204 manually samples trajectories near the target scene in the empty region. It is assumed that the camera movement between adjacent frames is sufficiently small such that a standard video upsampler can leverage sufficient temporal alignment.

The video upsampler module 206 then upsamples the intermediate video 212 rendered from the coarse 3D representation to gain resolution and obtain sharp results in an upsampled video 214. In general terms, a video upsampling machine-learning model is a type of artificial intelligence routine designed to increase the resolution of a video. The upsampler takes a low-resolution video as input and outputs a higher-resolution version that appears sharper and more detailed. The machine-learning model is trained on a large dataset of video pairs, with each pair including a low-resolution video and its corresponding high-resolution version. During training, the model analyzes the video pairs and learns the complex relationships between low-resolution and high-resolution video frames by identifying patterns and features that differentiate high-resolution details from blurry, low-resolution ones. Once trained, the upsampler analyzes each frame of an input video and infers missing details based on the learned patterns to generate a higher-resolution version. Video upsamplers can, for example, employ convolutional neural networks or generative adversarial networks.

For example, FIG. 3 illustrates an example of three upsampled videos 214 generated from the intermediates videos 212. Given the trajectories 210 I_{1 . . . T} ∈ [symbol] describing the camera path for each individual video of the intermediate video 212, the video upsampler module 206 outputs a trajectory with ×r upsampling (e.g., r=4 in some implementations). Mathematically, this is represented as:

$${\hat{I}}_{1 … T} = f ( {I}_{1 … T} ) ∈ {ℝ}^{rW \times rH \times 3} , \qquad ( 1 )$$

where f denotes the video upsampler of the video upsampler module 206 and Î_{1 . . . T} is the upsampled video 214. The video upsampler module 206 assumes the initial rendering resolution is sufficiently high such that the rendered fidelity is bottlenecked by the coarse level of the input 3D representation.

The video upsampler module 206 can integrate various pre-trained generative video upsamplers. Additional fine-tuning is performed in scenarios where the input 120 includes domain bias. For example, with stripy or blob-like artifacts after zooming in, renderings from Gaussian splats follow different degradation from standard augmentations deployed in video upsamplers. Hence, pairs of low- and high-resolution videos depicting the specific degradation are used to finetune the video upsampler module 206.

For this purpose, a multi-view dataset that depicts various 3D objects and scenes is utilized. First, the finetuning process involves bilinearly downsampling the original images in the dataset by a factor of eight (8) (e.g., 64×64-pixel resolution) to obtain a set of low-resolution images. The low-resolution Gaussian splats are then fit to these images. The finetuning process renders the optimized low-resolution Gaussians in the original camera trajectory provided by the dataset as input to the video upsampler module 206. As the target ground truth, the original videos from the dataset are used, resized to be four (4) times the input's resolution. The video upsampler module 206 is finetuned using the Charbonnier regression loss for its robustness to outlier pixels, the learned perceptual image patch similarity (LPIPS) loss for its perceptual level improvements, and generative adversarial network (GAN) loss for its generative behavior.

The reconstruction module 208 then performs 3D reconstruction to generate a consistent 3D representation as Gaussian splats 216 from the upsampled video 214. For example, FIG. 3 illustrates a set of Gaussian splats 216 generated by the reconstruction module 208 from the upsampled videos 214, which a particular Gaussian splat illustrated as output 122. The reconstruction module 208 generates a high-fidelity 3D representation in the form of Gaussian splats 216 (note that camera views are known in the setup and do not need to be estimated), which is denoted φ_{high}. This final 3D optimization produces a true 3D output, removing any remaining temporal inconsistencies in the upsampled video 214.

The reconstruction module 208 leverages the concept of Gaussian splats to effectively represent the scene in a way that captures details and lighting effects. From the upsampled video 214, the reconstruction module 208 extracts key features like colors, edges, and lighting information, which are then used to create a set of 3D Gaussian splats 216. Each Gaussian splat 216 has a position in space, a size and orientation, a color, and an opacity value. These properties determine how the splat contributes to the final 3D model 118. An optimization algorithm is generally used to adjust the properties of the Gaussian splats 216 iteratively to minimize the difference between the reconstructed scene rendered from the Gaussian splats 216 and the actual video frames of the upsampled video 214.

The reconstruction module 208 performs an optimization process for the Gaussian splatting by running, for example, 2,000 steps. Because the super-resolution module 116 has “perfect” camera information, it is directly provided to the optimization process. The reconstruction module 208 uses L₁ (e.g., mean absolute error (MAE)) and L_{SSIM} (e.g., structural similarity index measure loss function) losses when optimizing the Gaussian splats. The advantages of adopting 3D Gaussian splatting lie in its object-centric representation and its efficiency in training and rendering. Besides, Gaussian splatting captures view-dependent effects well for the upsampled frames of the upsampled video 214. In addition, Gaussian splatting is also integrable and integrated with other types of 3D representations.

In addition to leveraging the prior of the video upsampler module 206, which is trained on a large set of video data, the reconstruction module 208 performs fine-tuning over domain-specific low-resolution videos (e.g., videos rendered from low-resolution 3D representations). As a result, the super-resolution module 116 handles complicated degradation caused by various 3D capture and generation processes.

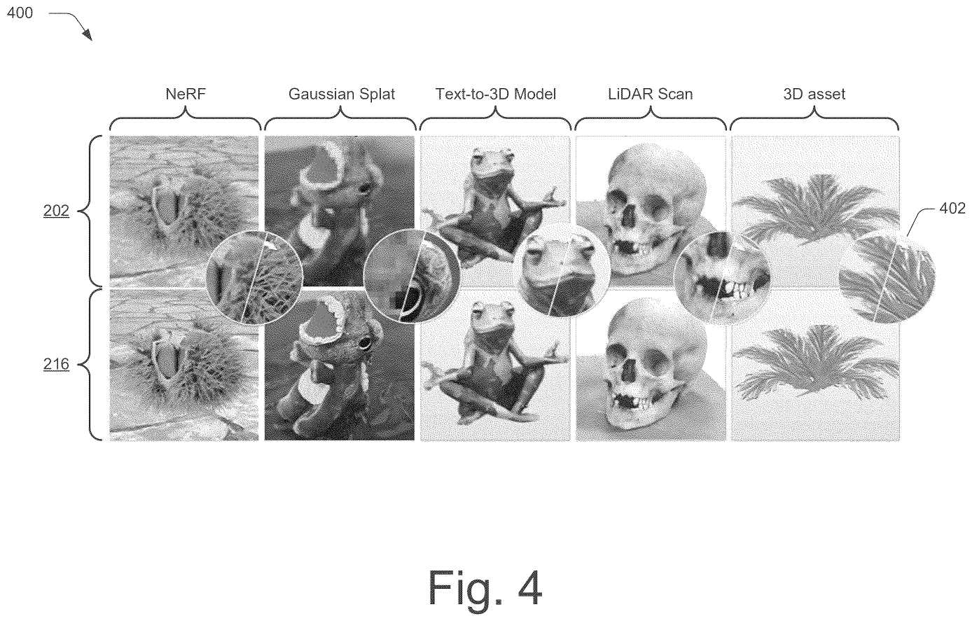

FIG. 4 depicts an example collection 400 of inputs and outputs of a super-resolution module. The super-resolution module 116 receives diverse sets of low-resolution 3D representations 202 (e.g., coarse input formats) of objects or scenes. In the example collection 400, the format of the low-resolution 3D representations 202 include NeRF, Gaussian splats, a text-to-3D model output, a LiDAR scan, and a 3D asset. Given the low-resolution 3D representation 202, the super-resolution module 116 performs upsampling to improve the fidelity of the 3D representation and output Gaussian splats 216 with more local details, illustrated by the zoom-in comparisons 402. As the zoom-in comparisons 402 illustrate, the Gaussian splats 216 include rich geometric and texture details not present in the low-resolution 3D representations 202.

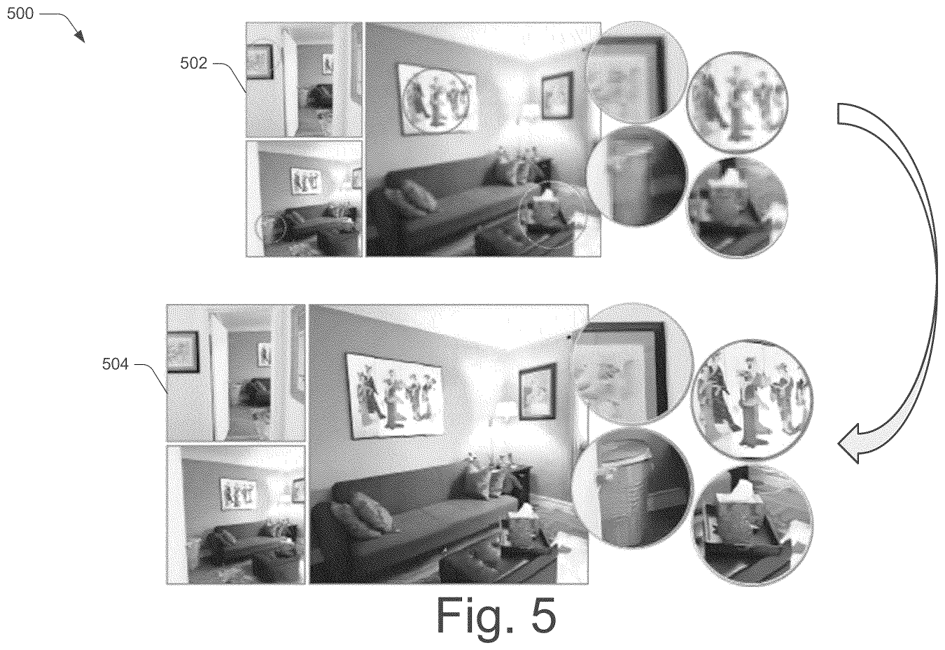

FIG. 5 depicts an example 500 of an input scene 502 and output scene 504 of a super-resolution module 116. The input scene 502 includes non-object-centric images of a hallway and living room with multiple items. The super-resolution module 116 applies the described techniques to upsample the input scene 502 and generate the output scene 504 with a much higher resolution. The four zoom-ins of different items within the scenes exemplify the improved resolution.

### Example Three-Dimensional Super-Resolution Procedures

The following discussion describes implementable techniques utilizing the previously described systems and devices. Aspects of each procedure are implementable in hardware, firmware, software, or a combination thereof. The procedures are shown as blocks that specify operations performed by one or more devices and are not necessarily limited to the orders shown for performing the operations by the respective blocks. In portions of the following discussion, reference is made to FIGS. 1-5.

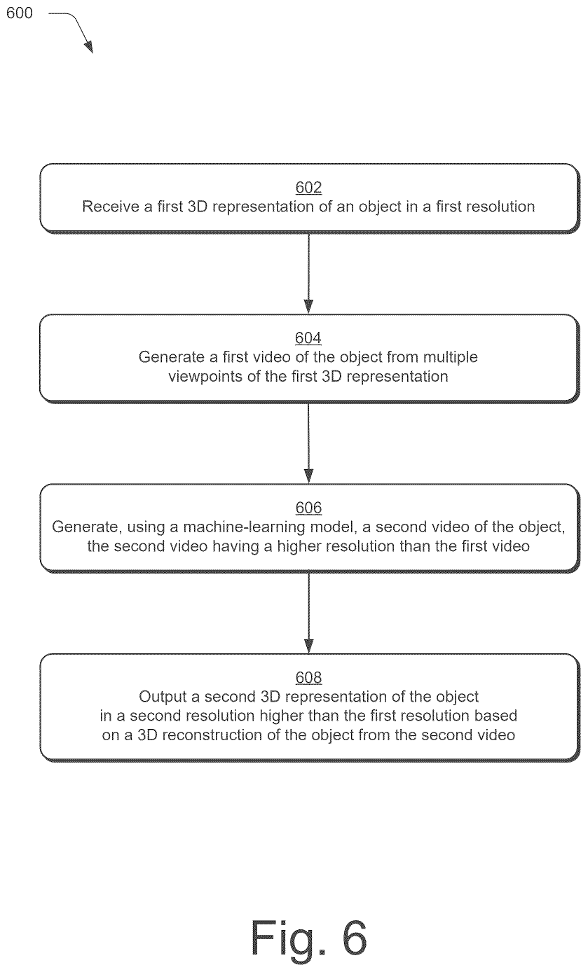

FIG. 6 depicts a procedure 600 in an example implementation of three-dimensional super-resolution using generative video models. A first 3D representation of an object is received in a first resolution (block 602). For example, the modality or format of the first 3D representation is Gaussian splats, NeRFs, a low-poly mesh, a digital video, data from a sensor scan (e.g., of a LiDAR or radar system), or a 3D object (e.g., output or generated by a text-to-3D machine-learning model).

A first video of the object is then generated from multiple viewpoints of the first 3D representation (block 604). The first video, which includes a sequence of (RGB) images, depicts the object from multiple viewpoints that are along a view trajectory. In some implementations, multiple first videos are generated from different smooth view trajectories. The camera movement between adjacent frames of the first video is generally assumed to be sufficiently small such that an upsampler can leverage temporal alignment.

A machine-learning model generates a second video of the object from the first video (block 606). The second video has a higher resolution than the first video. The machine-learning model is generally a pre-trained video-based generative upsampler. In at least one implementation, the upsampler model is fine-tuned to handle artifacts associated with the format or modality of the first 3D representation.

A second 3D representation of the object is output based on a 3D reconstruction of the object from the second video (block 608). The second 3D representation is in a second resolution higher than the first resolution. Generally, the second 3D representation is output as Gaussian splats and generated from the second video using 3D reconstruction that fits the Gaussian splats to the object in the second video.

### Example System and Device

FIG. 7 illustrates an example system 700 that includes an example computing device 702 that is representative of one or more computing systems and/or devices that implement the various techniques described herein. This is illustrated through inclusion of the super-resolution module 116. The computing device 702 is configurable, for example, as a server of a service provider, a device associated with a client (e.g., a client device), an on-chip system, and/or any other suitable computing device or computing system.

The example computing device 702, as illustrated, includes a processing system 704, one or more computer-readable media 706, and one or more I/O interface 708 that are communicatively coupled to one another. Although not shown, the computing device 702 further includes a system bus or other data and command transfer system that couples the various components from one to another. A system bus includes any one or combination of different bus structures, such as a memory bus or memory controller, a peripheral bus, a universal serial bus, and/or a processor or local bus that utilizes various bus architectures. Various other examples are also contemplated, such as control and data lines.

The processing system 704 is representative of the functionality to perform one or more operations using hardware. Accordingly, the processing system 704 is illustrated as including hardware element 710 that is configurable as processors, functional blocks, and so forth. This includes implementation in hardware as an application-specific integrated circuit or other logic device formed using one or more semiconductors. The hardware elements 710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 706 is illustrated as including memory/storage 712. The memory/storage 712 represents memory/storage capacity associated with one or more computer-readable media. The memory/storage 712 includes volatile media (such as random access memory (RAM)) and/or nonvolatile media (such as read-only memory (ROM), Flash memory, optical disks, magnetic disks, and so forth). The memory/storage 712 includes fixed media (e.g., RAM, ROM, a fixed hard drive, and so on) and removable media (e.g., Flash memory, a removable hard drive, an optical disc, and so forth). The computer-readable media 706 is configurable in various ways, as described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in various ways to support user interaction, as further described below.

Various techniques are described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques are configurable on various commercial computing platforms with various processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium configured to transmit instructions to the hardware of the computing device 702, such as via a network. Signal media typically embodies computer-readable instructions, data structures, program modules, or other data in a modulated data signal, such as carrier waves, data signals, or another transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representatives of modules, programmable device logic, and/or fixed device logic implemented in a hardware form that is employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employed to implement various techniques described herein. Accordingly, software, hardware, or executable modules are implemented as instructions and/or logic embodied on some form of computer-readable storage media and/or by one or more hardware elements 710. The computing device 702 is configured to implement particular instructions and/or functions corresponding to the software and/or hardware modules. Accordingly, implementation of a module executable by the computing device 702 as software is achieved at least partially in hardware, e.g., through computer-readable storage media and/or hardware elements 710 of the processing system 704. The instructions and/or functions are executable/operable by one or more articles of manufacture (for example, one or more computing devices and/or processing systems 704) to implement techniques, modules, and examples described herein.

The techniques described herein are supported by various configurations of the computing device 702 and are not limited to the specific examples of the techniques described herein. This functionality is also implementable through a distributed system, such as over a “cloud” 714 via a platform 716 as described below.

Cloud 714 includes and/or represents a platform 716 for resources 718. Platform 716 abstracts the underlying functionality of hardware (e.g., servers) and software resources of the cloud 714. Resources 718 include applications and/or data that can be utilized when computer processing is executed on remote servers from the computing device 702. Resources 718 can also include services provided over the Internet and/or through a subscriber network, such as a cellular or Wi-Fi network.

Platform 716 abstracts resources and functions to connect computing device 702 with other computing devices. The platform 716 also serves to abstract scaling of resources to provide a corresponding level of scale to encountered demand for the resources 718 implemented via the platform 716. Accordingly, in an interconnected device embodiment, the implementation of functionality described herein is distributable throughout the system 700. For example, the functionality is implementable in part on the computing device 702 and via the platform 716, which abstracts the functionality of the cloud 714.

What is claimed is:

1. A method comprising:
receiving, by a processing device, a first three-dimensional (3D) representation of an object in a first resolution;
generating, by the processing device, a first video of the object from multiple viewpoints of the first 3D representation;
generating, using a machine-learning model and from the first video, a second video of the object in a higher resolution than the first video; and
outputting, by the processing device, a second 3D representation of the object in a second resolution higher than the first resolution and based on a 3D reconstruction of the object from the second video.

2. The method of claim 1, wherein a format of the first 3D representation is one of Gaussian splats, neural radiance fields (NeRFs), a low-poly mesh, a digital video, a sensor scan of a lidar or radar system, or a 3D object generated by another machine-learning model.

3. The method of claim 2, wherein the other machine-learning model is a text-to-3D generative model that generates the first 3D representation based on a text prompt.

4. The method of claim 1, wherein the multiple viewpoints of the first video follow a trajectory around at least a portion of the object.

5. The method of claim 4, wherein the first video includes multiple first videos that each follow a respective trajectory around at least a respective portion of the object.

6. The method of claim 4, wherein the first video comprises a sequence of red-green-blue (RGB) images of the object.

7. The method of claim 4, wherein camera movement between adjacent frames of the first video is sufficiently small for the machine-learning model to assume temporal alignment in the first video.

8. The method of claim 1, wherein the machine-learning model is a video-based generative upsampler.

9. The method of claim 8, wherein the video-based generative upsampler is fine-tuned to reduce artifacts of a format of the first 3D representation.

10. The method of claim 8, wherein the video-based generative upsampler is trained on a dataset of video pairs, each video pair including a low-resolution video and a corresponding high-resolution video.

11. The method of claim 1, wherein a format of the second 3D representation is Gaussian splats, each Gaussian splat indicating a position in space, a size value, an orientation, a color, and an opacity value.

12. The method of claim 11, wherein the second 3D representation is generated by fitting the Gaussian splats to the object from the second video.

13. A system comprising:
a memory component; and
one or more processing devices coupled to the memory component, the one or more processing devices to perform operations comprising:
receive a first three-dimensional (3D) representation of an object in a first resolution;
generate a first video of the object from multiple viewpoints of the first 3D representation;
generate, using a machine-learning model and from the first video, a second video of the object in a higher resolution than the first video;
generate a second 3D representation of the object in a second resolution higher than the first resolution by fitting Gaussian splats to the object from the second video; and
output the second 3D representation of the object.

14. The system of claim 13, wherein a format of the first 3D representation is one of the Gaussian splats, neural radiance fields (NeRFs), a low-poly mesh, a digital video, a sensor scan of a lidar or radar system, or a 3D object generated by another machine-learning model.

15. The system of claim 13, wherein the machine-learning model is a video-based generative upsampler.

16. The system of claim 15, wherein the video-based generative upsampler is fine-tuned to reduce artifacts of a format of the first 3D representation.

17. The system of claim 13, wherein each Gaussian splat of the second 3D representation indicates a position in space, a size value, an orientation, a color, and an opacity value.

18. The system of claim 13, wherein the first video includes multiple first videos that each follow a respective trajectory around at least a respective portion of the object.

19. The system of claim 13, wherein the object comprises a scene or environment with multiple items.

20. A non-transitory computer-readable storage medium storing executable instructions, which when executed by a processing device, cause the processing device to perform operations comprising:
receiving a first three-dimensional (3D) representation of an object in a first resolution in a first format;
generating a first video of the object from multiple viewpoints of the first 3D representation;
generating, using a machine-learning model and from the first video, a second video of the object in a higher resolution than the first video; and
outputting a second 3D representation of the object in a second resolution higher than the first resolution and based on a 3D reconstruction of the object from the second video.
